(19) United States
(12) Patent Application Publication
(10) Pub. No.: US 2010/0192091 A1
(43) Pub. Date: Jul. 29, 2010

(54) IMAGE PROCESSING METHOD, PROGRAM THEREOF, AND IMAGE PROCESSING APPARATUS

(75) Inventors: Satoru Oishi, Sapporo-shi (JP); Yasuhide Kumagai, Sapporo-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/695,032

(22) Filed: Jan. 27, 2010

(30) Foreign Application Priority Data
Jan. 28, 2009 (JP) 2009-017132

(51) Int. Cl. G06F 3/048

(52) U.S. Cl. 715/799; 715/800

(57) ABSTRACT

Provided is an image processing method in a program that is linked with a separate program and displays a window by being activated on the basis of the separate program, the separate program being executed in an image processing apparatus having a plurality of display sections and displaying a window on any of the plurality of display sections. The image processing method includes: acquiring display information including information as to which of the plurality of display sections the window of the linked separate program is displayed on; determining whether or not a display section.

### BACKGROUND

1. Technical Field

The present invention relates to an image processing method, a program thereof, and an image processing apparatus.

2. Related Art

In the past, as a method of displaying a window on display screens of a plurality of display devices, there has been proposed an image processing method that detects the size of a displayed window and arrangement thereof on the display screens and, on the basis of such detection results, issues an instruction to rearrange the displayed window in the display screen of any one of the display devices (for example, refer to JP-A-2006-251465). The image processing method is capable of preventing the window from being displayed across a plurality of screens, thereby enabling improvement in visibility of the window for a user.

However, in such a method of displaying a window on a plurality of display devices as disclosed in JP-A-2006-251465, a plurality of programs may be separately activated. In this case, the windows of the activated programs are respectively displayed on predetermined display devices (for example, a primary display device). Here, in a state where the window is displayed on a display device other than the predetermined display device, sometimes a separate program linked with the program of the window may be activated from the program of the window. In such a case, the window of the separate program linked therewith may be displayed on a separate display device, and thus sometimes the user's operability may deteriorate.

### SUMMARY

An advantage of some aspects of the invention is that it provides an image processing method, which is capable of improving further a user's operability when executing programs by using a plurality of display sections, a program thereof, and an image processing apparatus.

In order to achieve the above-mentioned main advantage, the invention employs the following means.

According to an aspect of the invention, provided is an image processing method in a program that is linked with a separate program and displays a window by being activated on the basis of the separate program, the separate program being executed in an image processing apparatus having a plurality of display sections and displaying a window on any of the plurality of display sections. The image processing method includes the following steps of: (a) acquiring display information including information as to which of the plurality of display sections the window of the linked separate program is displayed on; (b) determining whether or not a display section, on which the window of the separate program is displayed, is different from a display section, on which a window is intended to be displayed after the current time, on the basis of the display information acquired in the step (a); and (c) moving the window, which is intended to be displayed, so as to make the window visible on the display section, on which the window of the separate program is displayed, when the determination result in the step (b) is that the display section, on which the window is intended to be displayed, is different.

In the image processing method, display information is acquired which includes information as to which of the plurality of display sections the window of the linked separate program is displayed on; it is determined whether or not a display section, on which the window of the separate program is displayed, is different from a display section, on which a window is intended to be displayed after the current time, on the basis of the acquired display information; and when the determination result is that the display section, on which the window is intended to be displayed, is different, the window, which is intended to be displayed, is moved to be visible on the display section, on which the window of the separate program is displayed. For example, in an apparatus having a plurality of display sections, a separate program linked with a program currently operated may be activated. In this case, those are programs separate from each other, and thus sometimes a new window may be displayed on a display section different from the display section currently operated. In the aspect of the invention, newly displayed window is displayed on the same display section even in the linked separate program. Accordingly, it is possible to improve further the user's operability. Here, the “separate program” may be defined as a program that is activated by another program but independently operates, and may also be defined as a program that has no relationship of a parent process and a child process. Furthermore, it is assumed that the separate program does not include a multi-thread that performs a parallel processing by one program.

In this case, in the step (b), it may be determined whether or not a display section, on which the window of the separate program is displayed, is different from a display section, which is previously determined in an initial display of the window, on the basis of the display information acquired in the step (a). In addition, in the step (c), when the determination result in the step (b) is that the display section, on which the window is intended to be displayed, is the same, the process of moving the window may be not performed. In contrast, when the display section, on which the window is intended to be displayed, is different, the window, which is intended to be displayed, may be moved to be visible on the display section, on which the window of the separate program is displayed. Further, in the step (c), in the moving of the window, which is intended to be displayed, for making the window visible on the display section on which the window of the separate program is displayed, the arrangement position of the window intended to be displayed may be set on a display section on which the window of the separate program is displayed.

In the image processing method according to the aspect of the invention, in the step (a), it is preferable that the display information be acquired by acquiring information on a window currently displayed on the top of the screen through an application program interface (API) of an operating system (OS). The program is a separate program even though linked. Thus, when a window is activated from the separated program, it is difficult to verify which display section the window of the separated program is displayed on. However, there is a high possibility that the window currently displayed on the top of the screen is displayed right after activation of the program according to the aspect of the invention is operated. As a result, by using the information of the window displayed on the top of the screen, it is possible to more easily acquire the information of the display section on which the window of the linked separate program is displayed.

In the image processing method according to the aspect of the invention, in the step (a), it is preferable to acquire the display information further including information on displayable regions as regions excluding taskbar regions from respective screen regions of the plurality of display sections. In addition, in the step (c) of moving the window, which is intended to be displayed, so as to make the window visible on the display section on which the window of the separate program is displayed, it is preferable to resize the window intended to be displayed on the basis of a ratio of a displayable region of the display section on which the window of the separate program is displayed to a displayable region of the display section on which a window is intended to be displayed after the current time. In such a manner, by performing the resizing on the basis of the ratio of the displayable regions of the display sections, it is possible to move the window so as to be more clearly visible. Alternatively, in the step (a), it is preferable to acquire the display information further including information on respective resolutions of the plurality of display sections. In addition, in the step (c) of moving the window, which is intended to be displayed, so as to make the window visible on the display section on which the window of the separate program is displayed, it is preferable to resize the window intended to be displayed on the basis of a ratio of a resolution of the display section on which the window of the separate program is displayed to a resolution of the display section on which a window is intended to be displayed after the current time. In such a manner, by performing the resizing on the basis of the ratio of the resolutions of the display sections, it is possible to move the window so as to be more clearly visible. Alternatively, in the step (c) of moving the window, which is intended to be displayed, so as to make the window visible on the display section on which the window of the separate program is displayed, it is preferable to resize the window intended to be displayed at a predetermined ratio. In such a manner, by performing the resizing at the predetermined ratio, it is possible to move the window so as to be more clearly visible. Here, the “predetermined ratio” may be defined as a value which is empirically calculated so as to make the window visible. Alternatively, in the step (a), it is preferable to acquire the display information further including information on respective screen regions of the plurality of display sections. In addition, in the step (c) of moving the window, which is intended to be displayed, so as to make the window visible on the display section on which the window of the separate program is displayed, it is preferable to resize the window intended to be displayed on the basis of a ratio of a screen region of the display section on which the window of the separate program is displayed to a screen region of the display section on which a window is intended to be displayed after the current time. In such a manner, by performing the resizing on the basis of the ratio of the screen regions of the display sections, it is possible to move the window so as to be more clearly visible.

In the image processing method according to the aspect of the invention, in the step (a), it is preferable to acquire the display information further including information on a displayable region as a region excluding a taskbar region from a screen region of the display section, on which the window of the separate program is displayed, of the plurality of display sections. In addition, in the step (c) of moving the window, which is intended to be displayed, so as to make the window visible on the display section on which the window of the separate program is displayed, it is preferable that a position of the window, which is intended to be displayed, be set so as to make the window be included in the displayable region. In such a manner, it is possible to suppress hiding in the taskbar region, and move the window so as to make it more clearly visible.

In this case, in the step (c), the window may be resized and subsequently the position of the window may be set so as to make the resized window be included in the screen region (the displayable region) of display section on which the window of the separate program is displayed. Alternatively, in the step (c), the position of the window intended to be displayed may be set so that the window is moved to be included in the screen region (the displayable region) of display section on which the window of the separate program is displayed, and subsequently the widow may be resized. In this case, in the step (c), it is determined whether or not the window intended to be displayed is included in the displayable region if it is moved. When the determination result is that the window is included in the displayable region, the position of the window may be set. When the determination result is that the window is not included in the displayable region, the window may be resized, and subsequently the position of the resized window may be set so as to make the window be included in the displayable region.

In the image processing method according to the aspect of the invention, it is preferable that the step (a), the step (b) and the step (c) be executed by an initialization process at the time of program activation. In such a manner, it is possible to display the moved window on the display section by preventing the unmoved window from being displayed on the different display device. As a result, a user can perform an operation without sense of discomfort.

According to another aspect of the invention, a program is for causing one or a plurality of computers to execute the above-mentioned image processing method. The program may be recorded on a computer-readable recording medium (for example, a hard disk, a ROM, an FD, a CD, a DVD, or the like), may be transmitted to a separate computer from a computer which is linked with a transmission medium (a communication network such as an internet or a LAN), and may be transmitted and received in any other forms. When one computer executes the program or a plurality of computers respectively execute the steps, the respective steps of the above-mentioned image processing method are executed. As a result, it is possible to obtain the same advantages as those of the control method.

According to a further aspect of the invention, provided is an image processing apparatus for executing a program that is linked with a separate program of displaying a window and displays a window by being activated on the basis of the separate program. The image processing apparatus includes: a plurality of display sections; and a control unit that acquires display information including information as to which of the plurality of display sections the window of the linked separate program is displayed on, determines whether or not a display section, on which the window of the separate program is displayed, is different from a display section, on which a window is intended to be displayed after the current time, on the basis of the acquired display information, and moves the window, which is intended to be displayed, so as to make the window visible on the display section, on which the window of the separate program is displayed, when the determination result is that the display section, on which the window is intended to be displayed, is different.

In the image processing apparatus, similarly to the image processing method, the newly displayed window and the window of the separate program are displayed on the same display section even when the separate program is linked. Accordingly, it is possible to improve further the user's operability. Furthermore, the image processing apparatus may employ the aspect of the image processing method, and may further have functions of executing the respective steps of the above-mentioned image processing method.

### BRIEF DESCRIPTION OF THE DRAWINGS

The invention will be described with reference to the accompanying drawings, wherein like numbers reference like elements.

FIG. 1 is a configuration diagram illustrating a schematic configuration of a printer system.

FIG. 2 is an explanatory diagram of display information stored in a RAM.

FIG. 3 is an explanatory diagram of display screens of a first display and a second display.

FIG. 4 is a flowchart showing an example of a routine of a process of displaying a linked window.

FIG. 5 is an explanatory diagram of the process of displaying the linked window.

FIG. 6 is a flowchart showing an example of a routine of a process of displaying a separate linked window.

FIG. 7 is an explanatory diagram of the process of displaying the linked window.

FIG. 8 is a flowchart showing an example of a routine of a process of displaying a separate linked window.

FIG. 9 is an explanatory diagram in which a first screen region and a second screen region are vertically arranged.

### DESCRIPTION OF EXEMPLARY EMBODIMENTS

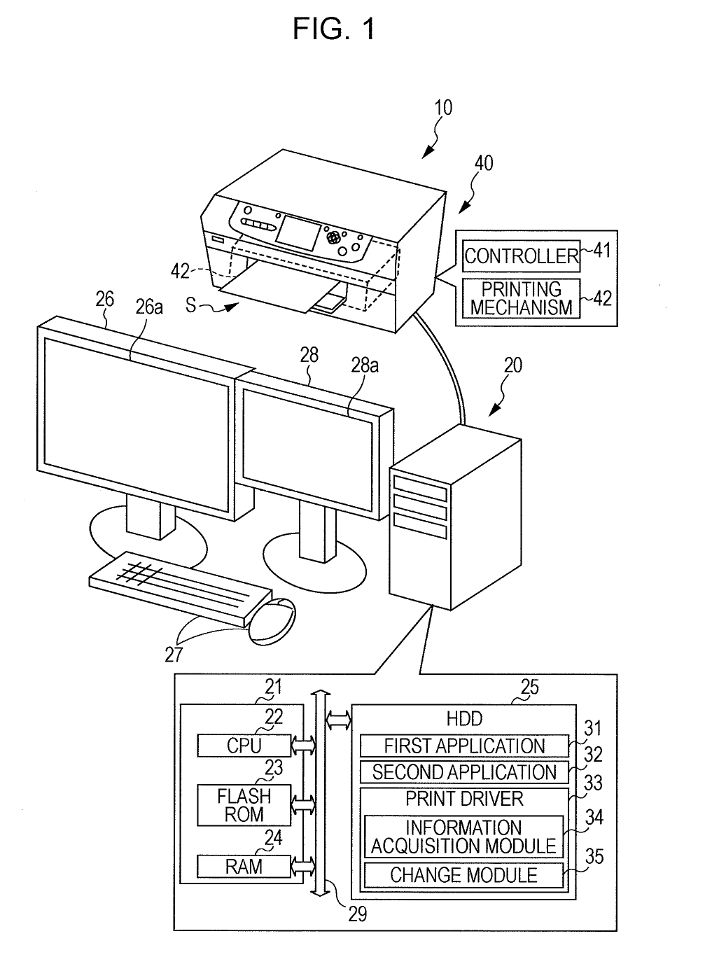

Next, an embodiment of the invention will be described with reference to the accompanying drawings. FIG. 1 is a configuration diagram illustrating a schematic configuration of a printer system 10 according to the embodiment of the invention. The printer system 10 of the embodiment includes, as shown in FIG. 1, a user PC (PC) 20 that processes data and displays the data on a screen, and a printer 40 that receives a print job from the user PC 20 and executes a printing process.

The user PC 20 is a well-known normal personal computer configured as an image processing apparatus used by a user, and has a plurality of display devices, that is, is configured to enable so-called multi display. The user PC 20 includes a controller 21 and a HDD 25. The controller 21 includes a CPU 22 that executes various controls, a flash ROM 23 that stores various control programs, and a RAM 24 that temporarily stores data. The HDD 25 is a high-capacity memory that stores various application programs and various data files. The HDD 25 stores a first application 31 (for example, a text editing program) that is an execution program and a second application 32 (for example, a spreadsheet program) that is a program separate from the first application 31. Further, the HDD 25 stores a print driver 33, which is used when a print job is transmitted to the printer 40 and the printing process is performed, and the like. The print driver 33 is, for example, a program separate from the first application 31 and the second application 32, but has a configuration in which the driver is linked with those so as to enable activation from these programs. That is, the print driver 33 includes an information acquisition module 34 that has a function of acquiring display information on a linked place and an activation source and a change module 35 that has a function of moving and resizing a window screen of the print driver 33. The information acquisition module 34 and the change module 35 are functional modules of the print driver 33, and is not a separate program of the print driver 33. Furthermore, the “separate program” may be defined as a program that is activated by another program but independently operates, and may also be defined as a program that has no relationship of a parent process and a child process. Furthermore, it is assumed that the separate program does not include a multi-thread that performs a parallel processing by one program.

The user PC 20 further includes input devices 27 such as a keyboard and a mouse that allows a user to input various instruction, a first display device 26 that displays various information on a first screen region 26a, and a second display device 28 that displays various information on a second screen region 28a. In the user PC 20, the first display device 26 is determined as a primary (an initial activation place), and the second display device 28 is determined as a secondary. Further, it is assumed that the first display device 26 (for example, 1024×768 pixels) has a screen size larger than the second display device 28 (for example, 800×600 pixels). The user PC 20 has a function of executing an operation based on an input operation which is performed by allowing a user to operate a cursor and the like displayed on the first display device 26 and the second display device 28 through the input devices 27. The controller 21, the HDD 25, the input devices 27, and display devices 26 and 28 are electrically interconnected via a bus 29, and are configured to exchange various control signals and data. The user PC 20 instructs a printer 40 to perform the printing process and displays information on the printer 40 through installed programs.

The printer 40 includes a ROM that stores various processing programs, a RAM that temporarily stores data, a controller 41 that is configured by a micro processor having a CPU as its central element and has a function of control the entire apparatus, and a printing mechanism 42 that prints an image on a recording sheet S. The controller 41 and the printing mechanism 42 are electrically interconnected by a bus which is not shown in the drawing. The printing mechanism 42 is, although not shown in the drawing, is a ink jet type mechanism that performs the printing process by pressurizing respective color inks and ejecting the pressurized inks onto the recording sheet S. Furthermore, a mechanism for pressurizing the inks may be based on deformation of piezoelectric elements or occurrence of bubbles caused by heat of a heater.

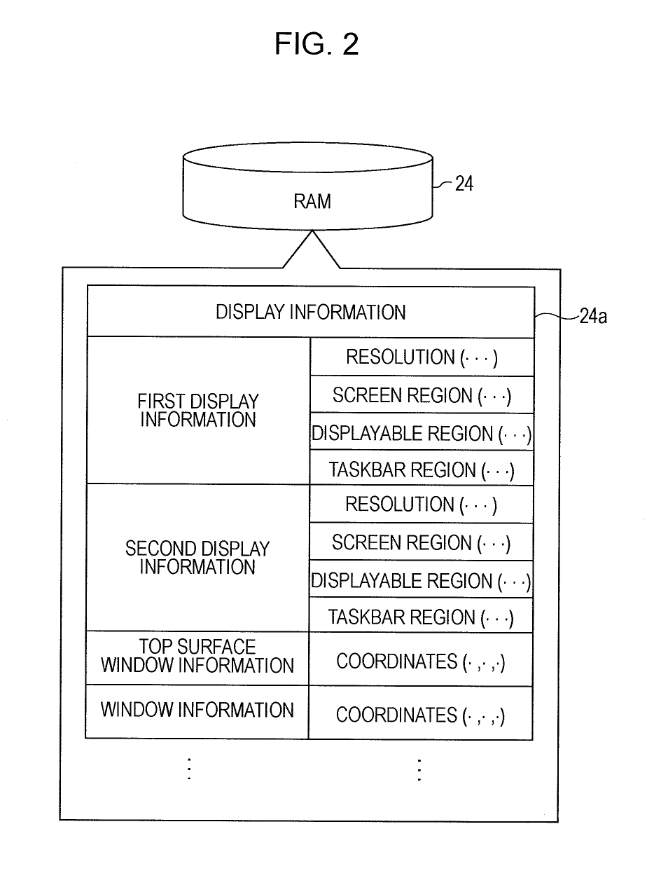

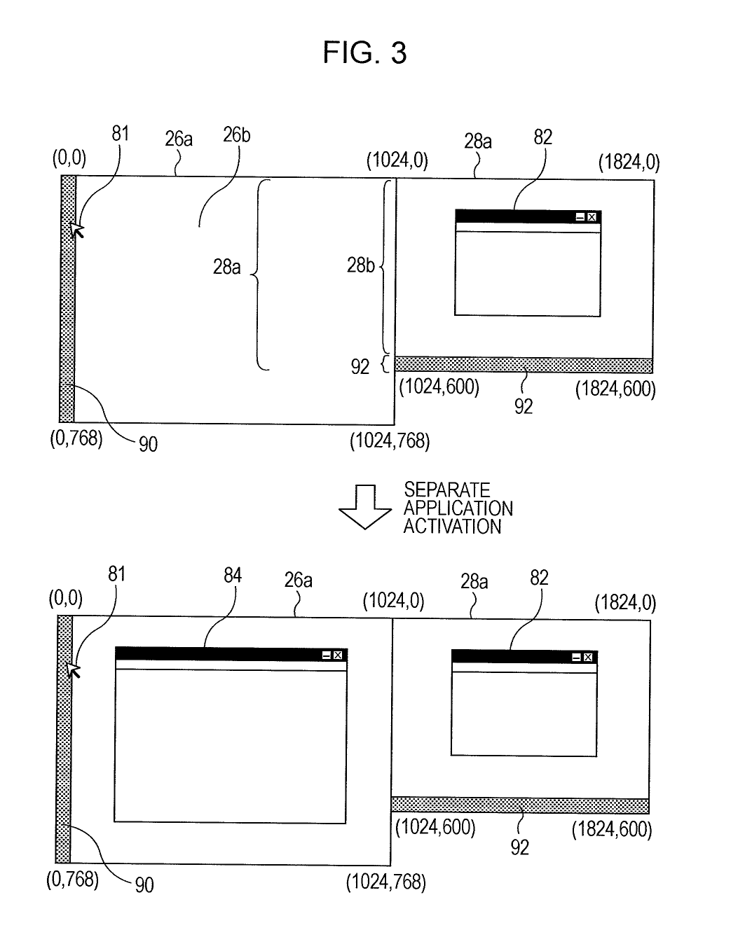

Next, operations of the printer system 10 of the embodiment configured in such a manner, in particular, the operation at the time of performing data processing in the user PC 20 will be described. FIG. 2 is an explanatory diagram of display information 24a stored in the RAM 24. FIG. 3 is an explanatory diagram of display screens of the first display device 26 and the second display device 28. In the user PC 20, when a computer is activated, the CPU 22 stores information on the first display device 26 and the second display device 28 and information on the display screen displayed on those as the display information 24a in a predetermined region of the RAM 24, by using an operating system (OS) which is not shown in the drawing. The display information 24a contains, as shown in FIG. 2, information on the first display device 26 and the second display device 28 such as resolutions thereof and sizes and coordinate values of screen regions, displayable regions, and the taskbar regions. On the basis of the display information 24a, as shown in the upper part of FIG. 3, arrangement of the windows is controlled by an X-Y coordinate including a plurality of screen regions. Further, the display information 24a contains information on one or more windows including a window, which is currently active and currently displayed on the top of the screen, such as sizes and coordinate values of the windows. In addition, when a user activates, for example, the first application 31, the CPU 22 stores the information (a position of arrangement and a size) on the window, which is intended to be displayed, in the display information 24a, and performs a process of displaying the window on the first screen region 26a, which is previously set as an initial activation place, by using the OS. As shown in FIG. 3, description will herein be given in priority to the case where a user moves a first window 82 of the first application 31 to the second display device 28 and conducts a work.

As shown in the upper part of FIG. 3, the first screen region 26a includes regions such as a taskbar region 90 and a displayable region 26b excluding the taskbar region 90 from the first screen region 26a. Further, the second screen region 28a includes regions such as a taskbar region 92 and a displayable region 28b excluding the taskbar region 92 from the second screen region 28a. Furthermore, region sizes and display positions of the taskbar regions 90 and 92 can be changed by an operation of a user. When the first window 82 is displayed on the second screen region 28a, the second application 32 which is a separate program may be activated by a user. In this case, as shown in the lower part of FIG. 3, the CPU 22 stores information on a second window 84 in the display information 24a, executes a predetermined initialization process of the second application 32, and subsequently performs a process of displaying the second window 84 of the second application 32 on a first screen region 26a of the initial activation place by using the OS. In such a manner, for example, when text editing is performed and spreadsheet work is conducted, that is, when separate work is conducted, a user can continue an operation without any problem even if a window is displayed on a separate display device.

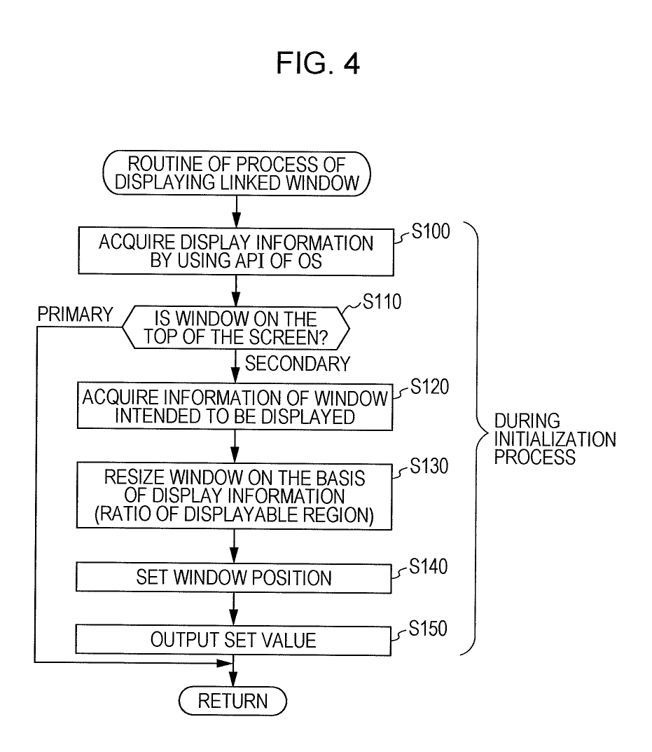

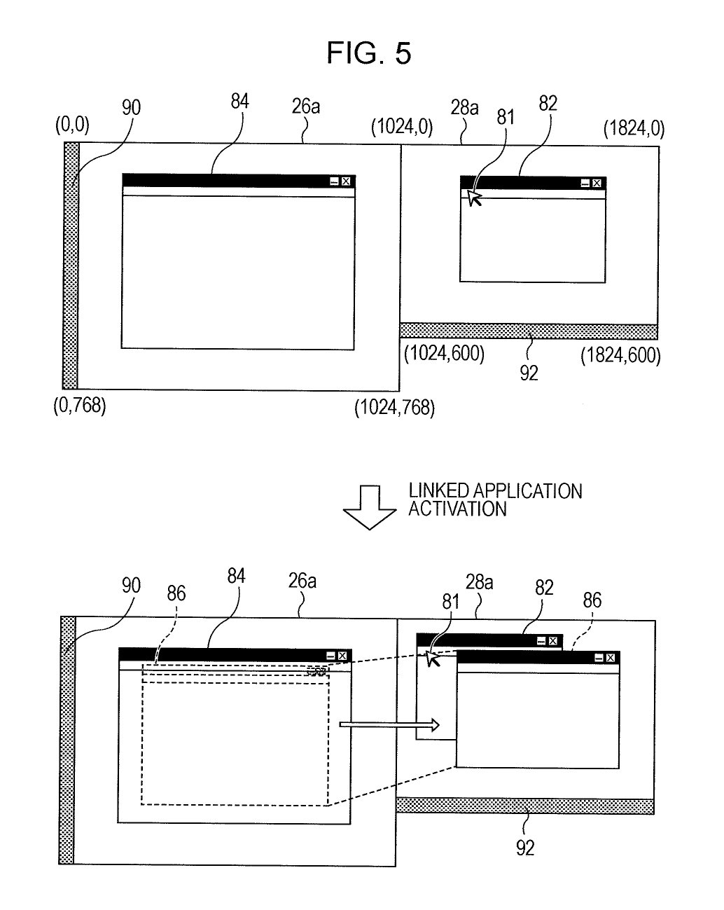

Next, the operation of the print driver 33, which is an application operating with another application linked therewith, will be described. FIG. 4 is a flowchart showing an example of a routine of a process of displaying a linked window executed by the CPU 22. FIG. 5 is an explanatory diagram of the process of displaying the linked window. The routine of the process of displaying the linked window is contained in the print driver 33 stored in the HDD 25, and is executed by the CPU 22 after the activation instruction is received from the linked application. Further, the routine of the process of displaying the linked window is executed during the initialization process before display of the window of the print driver 33. Description will herein be given with respect to a case where the print driver 33 is activated by the input of the print instruction from the first window 82 of the first application 31 which is displayed on the second screen region 28a.

When the routine is executed, first, the CPU 22 acquires the display information 24a by using the application program interface (API) of the OS (step S100). Here, a process is performed which acquires a window handle, which is currently active and displayed on the top of the screen, by using the API of the OS, and acquires the information on the first display device 26 and the second display device 28 by using the acquired window handle and the API of the OS. Furthermore, as the information on the first display device 26 and the second display device 28, information, which includes a resolution thereof, a flag indicating the display device where the window is displayed, the origin of the screen region of the display device, and coordinates of the displayable region, is acquired. In this case, when the printer driver 33 is activated from the first application 31 which is linked but is a separate program, it is difficult to verify which display section the window of the separate program is displayed on. Hence, it is regarded that the window displayed on the top of the screen activates the print driver 33, thereby acquiring the information on the window on the top of the screen.

Next, the CPU 22 determines whether the window on the top of the screen exists on the primary side or secondary side on the basis of the information on the display information 24a (step S110). This determination is performed by using the flag indicating the display device on which the window is displayed. If the window on the top of the screen exists on the primary side (the first display device 26 side), it is regarded that the linked window 86 of the print driver 33 may be displayed on the first display device 26 which is an initial activation place. In this case, the CPU 22 terminates the routine without changing the position of arrangement and the size of the set window. Then, the CPU 22 performs a process of displaying the linked window on a displayable region 26b, which is the initial activation place, on the basis of the information on the arrangement position and the size of the linked window 86 of the print driver 33, which is initially set, by using the OS. In such a manner, since the linked window is displayed on the same display device of the first window of the first application 31 which is the activation source, a user can perform an operation without sense of discomfort.

In contrast, if the window on the top of the screen exists on the secondary side (the second display device 28 side) in step S110, the information (the arrangement position and the size) of the window intended to be displayed is acquired from the current time (step S120). Then, the process of resizing the window is performed by the information on the displayable region of the display information 24a (step S130). Subsequently, setting of the window position is executed (step S140), the set value is output (step S150), and this routine is terminated. The resizing process and the setting of the arrangement position will be described. For example, the size of the linked window 86 can be changed by using the ratio of an area of the displayable region 26b to an area of the displayable region 28b. For example, the area of the displayable region 28b is divided by the area of the displayable region 26b, and is multiplied by the size of the linked window 86, thereby calculating a size thereof after resize. Furthermore, by separately calculating horizontal and vertical ratios of the displayable region 26b and the displayable region 28b, the respective sizes may be calculated. In addition, by applying smaller one of the horizontal and vertical ratios to both of the horizontal and vertical ratios, the size may be calculated. In such a manner, since the displayable regions 26b and 28b does not includes the taskbar regions 90 and 92, an aspect ratio of the linked window 86 is changed, but it is possible to more reliably resizing the liked window 86 to a size capable of making it be included in the displayable region 28b. Further, the setting of the window positions is calculated by separately calculating the horizontal and vertical ratios of the displayable region 26b and the displayable region 28b and by using the ratios so that a starting point initially set in a displayable region 26b coincides with a starting point of the displayable region 28b. Then, in step S150, the movement contents of the window are set by overwriting the information on the linked window 86 of the display information 24a with the information on the calculated coordinates of the arrangement position and the calculated size. When the initialization process is terminated, the CPU 22 displays the linked window 86 on the displayable region 28b on the basis of the information on the display information 24a by using the OS.

Next, the processes of steps S100 to S150 will be described with reference to FIG. 5. First, as shown in the upper part of FIG. 5, the second window 84 is displayed on the first screen region 26a of the first display device 26, and the first window 82 is displayed on the displayable region 28b of the second display device 28. In this state, a user operates a cursor 81 so as to select the printing process from the first window 82. Then, the CPU 22 executes the initialization process of the print driver 33 by using the OS, and performs a process of setting the arrangement position and the size of the linked window 86 and storing those in the display information 24a. Furthermore, the arrangement position at this time is set on the primary side as indicated by a dotted line in the displayable region 26b shown in the lower part of FIG. 5. Here, the information acquisition module 34 of the print driver 33 reads out the display information 24a, and acquires the information on the display devices and the information on the window on the top of the screen. Then, if it is determined that the window on the top of the screen exists on the secondary side, the change module 35 of the print driver 33 creates the setting of the resizing and the arrangement position of the linked window 86 on the basis of the ratio of the displayable region 26b to the displayable region 28b. Due to such a change, as shown in the displayable region 28b of the lower part of FIG. 5, the linked window 86 is displayed on the displayable region 28b on which the first window 82 of the activation source is displayed. In such a manner, for example, similarly to the case where the text editing is performed and the printing process is performed, the linked window 86 is displayed on the same display device of the first window 82 of the first application 31 which is an activation source. Hence, a user can continue an operation without sense of disturbance.

Here, a correspondence relationship between components of the embodiment and components of the aspect of the invention is clarified. The routine of the process of displaying the linked window in step S100 of the embodiment corresponds to the step (a) of the aspect of the invention, step S110 corresponds to the step (b), and steps S120 to S150 correspond to the step (c). Furthermore, the embodiment describes operations of the user PC 20, thereby also clarifying an example of program and image processing apparatus of the aspect of the invention.

As described above, the routine of the process of displaying the linked window executed by the user PC 20 of the embodiment mentioned above includes the steps of: acquiring the display information 24a including information as to which display device the first window 82 of the linked first application 31 (the separate program) is displayed on; determining whether or not a display device, on which the first window 82 of the first application 31 is displayed, is different from a display device of the initial activation place on the basis of the acquired display information 24a; and stopping the moving process when the determination result is that the display devices are the same but moving the linked window 86, which is intended to be displayed, so as to make the window visible on the displayable region 28b, on which the first window 82 is displayed, when the determination result is that the display devices are different from each other. In such a manner, a newly displayed window is displayed on the same display device even in the linked separate program, and thus it is possible to improve further the user's operability.

Further, since the information on the window currently displayed on the top of the screen is acquired by using the API of the OS, it is possible to more easily acquire the information on the display section on which the window of the linked separate program is displayed. In addition, by acquiring the information of the respective displayable regions of the first display device 26 and the second display device 28, the setting of the arrangement position and the resizing of the window is performed on the basis of the ratio of these displayable regions. Thus, it is possible to suppress hiding in the taskbar region, and move the window so as to make it more clearly visible. Furthermore, the routine of the process of displaying the linked window is executed at the time of the initialization process. Hence, it is possible to display the moved window on the display section by preventing the unmoved window from being displayed on the different display device, and a user can perform an operation without sense of discomfort. In addition, generally the print driver 33 is linked with another application and is activated by the other application, and thus it is of great significance to apply the invention.

Furthermore, it is needless to say that the invention is not limited to the embodiment mentioned above and may be modified into various forms without departing from the technical spirit of the invention.

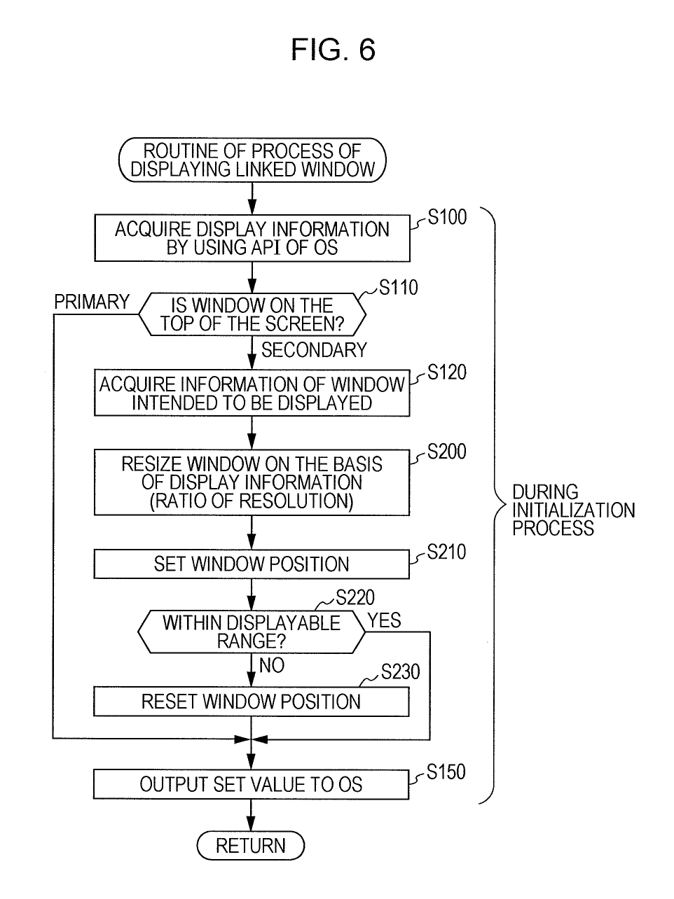

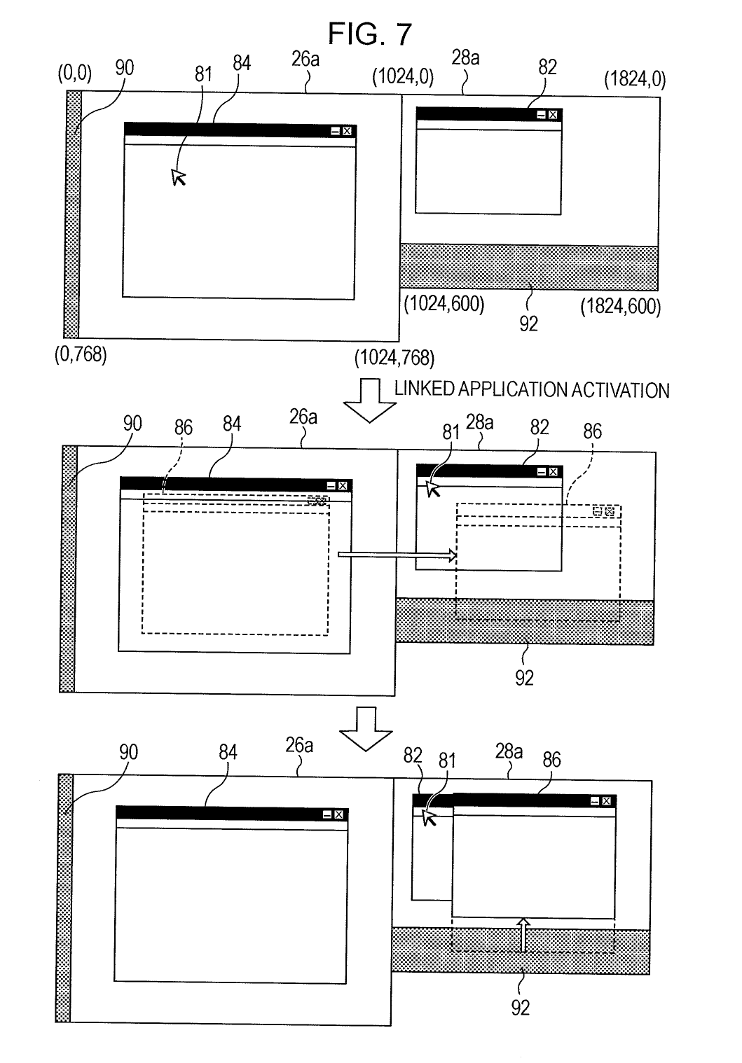

For example, in the above-mentioned embodiment, the linked window 86 intended to be displayed is resized and the arrangement position thereof is set on the basis of the ratios of the displayable region 26b and the displayable region 28b contained in the display information 24a. However, as shown in FIGS. 6 and 7, the linked window may be resized on the basis of the resolution ratio of the first display device 26 to the second display device 28 included in the display information 24a. FIG. 6 is a flowchart showing an example of the routine of the process of displaying the separate linked window. FIG. 7 is an explanatory diagram of the process of displaying the linked window. Furthermore, a process the same as the process of displaying the linked window is referenced by the same step numbers, and hereinafter description thereof will be omitted. When the routine is executed, the CPU 22 performs the above-mentioned steps S100 to S120, and resizes the linked window 86 intended to be displayed on the basis of the resolution ratio of the first display device 26 and the second display device 28 contained in the display information 24a (step S200). Then, the setting of the window position is performed on the basis of the resolution ratio (step S210). For example, the resolution of the second display device 28 is multiplied by the size of the linked window 86, and is divided by the resolution of the first display device 26, thereby calculating the size of the resized linked window 86. Further, the resolution of the second display device 28 is divided by the resolution of the first display device 26, and the coordinates of the arrangement position set on the first display device 26 are respectively converted, thereby setting the display position. Subsequently, the CPU 22 determines whether or not the set arrangement position and size thereof can be included in the displayable region 28b (step S220). This determination is a process that should be performed since some portion is hidden by the taskbar region 92, for example, as shown in the middle part of the FIG. 7, when the resizing is performed on the basis of the resolutions of the display devices. When the window is not included in the displayable region 28b, the CPU 22 resets the window position (step S230). In the resetting of the window position, as shown in the lower part of FIG. 7, a process of determining the starting point of the window is performed so that vertical and horizontal lengths of the resized window is included in the vertical and horizontal ranges of the displayable region 28b as possible as it can be. Then, after step S230, or in step S220, when the resized window is included in the displayable region 28b, directly the setting value is out put to the display information 24a in step S150, and this routine is terminated. In such a manner, also it is possible to improve further the user's operability since the newly displayed window is displayed on the same display device even in the linked separate program. Further, since the resizing is performed on the basis of the resolution ratio, the window can be moved to be more easily visible. In addition, since the resetting of the window position is performed in consideration of the taskbar region, the window can be moved to be more clearly visible.

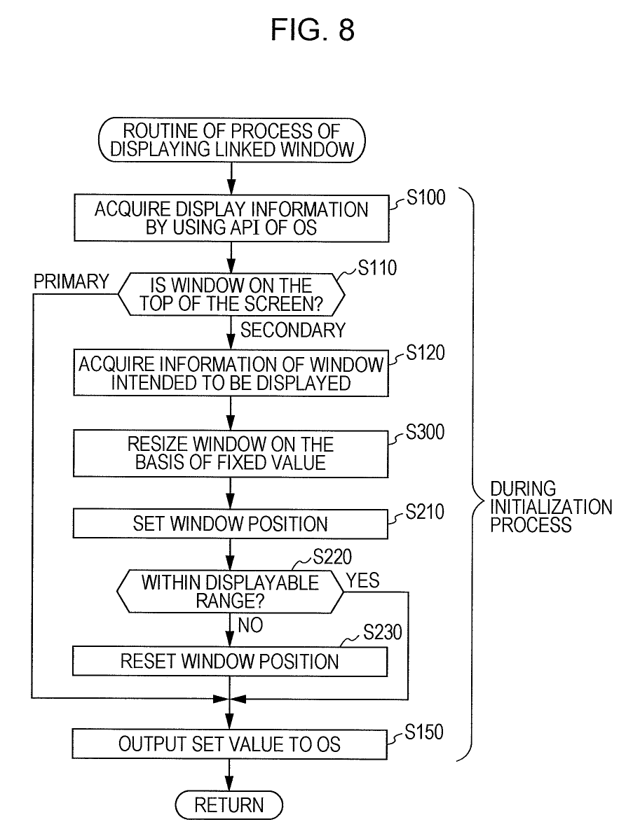

Alternatively, as shown in FIG. 8, the linked window 86 may be resized on the basis of a predetermined ratio (a fixed value). FIG. 8 is a flowchart showing an example of a routine of a process of displaying a separate linked window. The routine has the same resizing process based on the resolution except that the above-mentioned process of performing the resizing based on the resolution in step S200 is changed into a process of performing the resizing based on the fixed value. Furthermore, except for the resizing process, the same process of displaying the linked window in FIG. 7 is employed. The fixed value may be empirically set to a value (for example, ¾ or ⅗) that makes the resized and moved window visible. In such a manner, by performing the resizing with the predetermined ratio, the window can be moved to be more easily visible. Further, it is possible to perform the resizing process without using the display information 24a, and thus it is possible to simplify the process. Alternatively, in step S200 or step S300, the linked window may be resized on the basis of the ratios of the first screen region 26a and the second screen region 28a. In such a manner, by performing the resizing on the basis of the ratios of the screen regions of the display sections, the window can be moved to be more easily visible.

In the embodiment of the aspect of resetting the window position, the process of resetting the window position may be omitted. That is, the region of the window of which a portion is hidden in the taskbar region may be not considered. In such a manner, the newly displayed window is displayed on the same display device even in the linked separate program. Hence, it is possible to reduce the effort of moving the window so as to make the hidden portion visible, and it is also possible to improve the user's operability. Further, it is possible to simplify the process of moving the window.

In the above-mentioned embodiment, the linked window 86 intended to be displayed is resized, and subsequently the arrangement position is set so that the resized window is moved to the displayable region 28b. However, the invention is not limited to this. For example, by setting the arrangement position so that the linked window 86 is moved to the second screen region 28a first, it is determined whether or not the moved linked window 86 is included in the displayable region 28b, and if the linked window 86 is included in the displayable region 28b, the arrangement position is determined as it is. In this case, as described above, when the display devices are arranged on the right side and the left side, by horizontally moving the linked window 86 to the second screen region 28a, it is determined whether or not the moved linked window 86 is included in the displayable region 28b, and if not included, the linked window 86 may be moved vertically. On the other hand, if the linked window 86 is not included in the displayable region 28b, the linked window 86 may be resized. Furthermore, in the resizing method, as described in the embodiment mentioned above, it is possible to use, for example, the ratio of displayable region, the ratio of resolution, the ratio of screen region, the fixed value, and the like.

In the above-mentioned embodiment, the linked window 86 intended to be displayed is resized, and is moved to be included in the displayable region 28b. However, the arrangement position of the linked window 86 may be set so that the linked window 86 is included in the displayable region 28b without performing the resizing as possible as it can be. In order to make the linked window 86 be included in the displayable region 28b, for example, the shell of the displayable region 28b may be adjusted to the shell of the linked window 86, and the center of the displayable region 28b may be adjusted to the center of the linked window 86. Even in such a manner, the new window is displayed on the display device on which windows of the linked place and activation source are displayed. As a result, it is possible to improve visibility of the window and the user's operability further.

In the above-mentioned embodiment, the user PC 20 is configured to have two display devices, but may be configured to have three or more display devices. In such a manner, even when a plurality of display devices exists, the new window linked to the display device, on which the windows of the linked place and the activation source are displayed, is displayed. As a result, it is possible to improve the user's operability further.

In the above-mentioned embodiment, the primary display device is set as a display device of the initial activation place. The invention is not limited especially to this if the above-mentioned processes are performed when the windows are displayed on the different display devices at the time of the activation of the print driver 33 from the first window 82 of the first application 31 of the linked place. For example, the secondary display device may be set as the display device of the initial activation place.

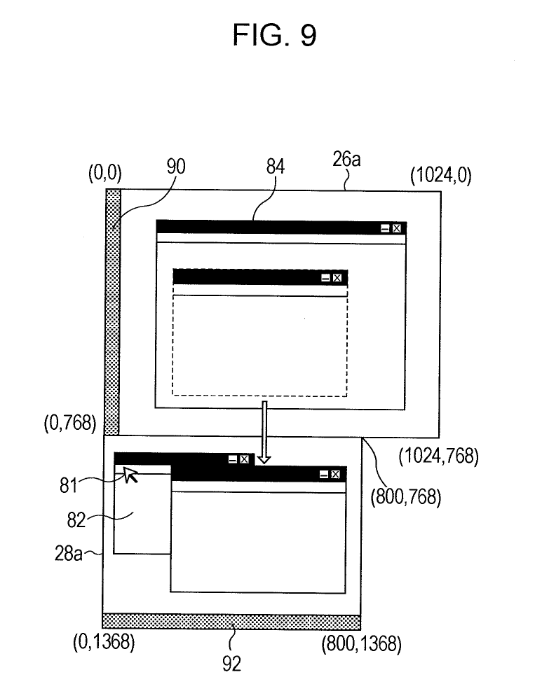

In the above-mentioned embodiment, the first display device 26 and the second display device 28 are arranged on the left side and right side, but as shown in FIG. 9, may be arranged vertically. FIG. 9 is an explanatory diagram in which the first screen region 26a and the second screen region 28a are vertically arranged. Even in such a manner, it is possible to obtain the same advantages as those of the above-mentioned embodiment.

In the above-mentioned embodiment, the screen region of the first display device 26 on the primary side is larger than that of the second display device 28 on the secondary side. However, the display device on the primary side may be smaller than the display device on the secondary side. In the above-mentioned embodiment, the process of resizing the linked window is a reducing process, but at this time, the process of the resizing the linked window may be set as an enlarging process, and the resizing may be not performed.

In the above-mentioned embodiment, the process of moving the linked window is performed during the initialization process, but the invention is not limited especially to this. Even in such a manner, the window may be displayed on the different display device for a moment, but thereafter the window is displayed on the same display device. As a result, it is possible to improve the user's operability further.

In the above-mentioned embodiment, it is described that the program of the aspect of the invention is the print driver 33. However, the invention is not limited especially to this, and may be applicable if the program is activated with a separate program linked therewith. Such a program includes, for example, a scanner driver, and the like.

In the above-mentioned embodiment, the user PC 20 is described, but the invention is not limited to this if electronics that executes a plurality of programs are provided. The invention is applicable to, for example, printing apparatuses such as the printer 40, an FAX, and a multi function printer having a scanner, portable information terminals such as home and mobile game machines, a picture viewer, a PDA, and a mobile phone, and the like.

The entire disclosure of Japanese Patent Application No. 2009-017132, filed Jan. 28, 2009, is expressly incorporated by reference herein

What is claimed is:

1. An image processing method in a program that is linked with a separate program and displays a window by being activated on the basis of the separate program, the separate program being executed in an image processing apparatus having a plurality of display sections and displaying a window on any of the plurality of display sections, the image processing method comprising:
acquiring display information including information as to which of the plurality of display sections the window of the linked separate program is displayed on;
determining whether or not a display section, on which the window of the separate program is displayed, is different from a display section, on which a window is intended to be displayed after the current time, on the basis of the acquired display information; and
moving the window, which is intended to be displayed, so as to make the window visible on the display section, on which the window of the separate program is displayed, when the determination result is that the display section, on which the window is intended to be displayed, is different.

2. The image processing method according to claim 1, wherein in the acquiring of the display information, the display information is acquired by acquiring information on a window currently displayed on the top of the screen through an application program interface (API) of an operating system (OS).

3. The image processing method according to claim 1,
wherein in the acquiring of the display information, the display information further including information on displayable regions as regions excluding taskbar regions from respective screen regions of the plurality of display sections is acquired, and
wherein in the moving of the window, which is intended to be displayed, for making the window visible on the display section on which the window of the separate program is displayed, the window intended to be displayed is resized on the basis of a ratio of a displayable region of the display section on which the window of the separate program is displayed to a displayable region of the display section on which a window is intended to be displayed after the current time.

4. The image processing method according to claim 1,
wherein in the acquiring of the display information, the display information further including information on respective resolutions of the plurality of display sections is acquired, and
wherein in the moving of the window, which is intended to be displayed, for making the window visible on the display section on which the window of the separate program is displayed, the window intended to be displayed is resized on the basis of a ratio of a resolution of the display section on which the window of the separate program is displayed to a resolution of the display section on which a window is intended to be displayed after the current time.

5. The image processing method according to claim 1, wherein in the moving of the window, which is intended to be displayed, for making the window visible on the display section on which the window of the separate program is displayed, the window intended to be displayed is resized at a predetermined ratio.

6. The image processing method according to claim 1,
wherein in the acquiring of the display information, the display information further including information on respective screen regions of the plurality of display sections is acquired, and
wherein in the moving of the window, which is intended to be displayed, for making the window visible on the display section on which the window of the separate program is displayed, the window intended to be displayed is resized on the basis of a ratio of a screen region of the display section on which the window of the separate program is displayed to a screen region of the display section on which a window is intended to be displayed after the current time.

7. The image processing method according to claim 1,
wherein in the acquiring of the display information, the display information further including information on a displayable region as a region excluding a taskbar region from a screen region of the display section, on which the window of the separate program is displayed, of the plurality of display sections is acquired, and
wherein in the moving of the window, which is intended to be displayed, for making the window visible on the display section on which the window of the separate program is displayed, a position of the window intended to be displayed is set so as to make the window be included in the displayable region.

8. The image processing method according to claim 1, wherein the acquiring of the display information, the determining of the difference, and the moving of the window are executed by an initialization process at the time of program activation.

9. A program for causing one or a plurality of computers to execute the image processing method according to claim 1.

10. An image processing apparatus for executing a program that is linked with a separate program of displaying a window and displays a window by being activated on the basis of the separate program, the image processing apparatus comprising:
a plurality of display sections; and
a control unit that
acquires display information including information as to which of the plurality of display sections the window of the linked separate program is displayed on,
determines whether or not a display section, on which the window of the separate program is displayed, is different from a display section, on which a window is intended to be displayed after the current time, on the basis of the acquired display information, and
moves the window, which is intended to be displayed, so as to make the window visible on the display section, on which the window of the separate program is displayed, when the determination result is that the display section, on which the window is intended to be displayed, is different.
